(19) United States
(12) Patent Application Publication
(10) Pub. No.: US 2003/0202093 A1
(43) Pub. Date: Oct. 30, 2003

(54) Film scanner

(75) Inventor: Yuichi Kurosawa, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/396,368

(22) Filed: Mar. 26, 2003

(30) Foreign Application Priority Data
Mar. 27, 2002 (JP) 2002-87892

(51) Int. Cl. H04N 7/18

(52) U.S. Cl. 348/95; 382/112

(57) ABSTRACT

A film scanner including a film holding device for holding a film to be scanned, an image pick-up device for scanning an image on the film in a main scanning direction, and a moving table having the film holding device mounted thereon, the moving table being movable with respect to the image pick-up device in a sub-scanning direction. The moving table includes an insertion portion into which the film holding device is inserted to be mounted on the moving table, the insertion portion allowing the film holding device to be inserted into the insertion portion only from a predetermined side of the moving table, and an insertion prevention device for preventing the film holding device from being inserted into the insertion portion in a position other than a predetermined position.

### BACKGROUND OF THE INVENTION

1. Field of the Invention

The present invention relates to a film scanner capable of capturing images formed on silver-salt photographic films, wherein the images are scanned via a photoelectric transfer device to be converted into image signals. More specifically, the present invention relates to this type of film scanner capable of preventing misoperations from occurring when a film holder or a film adapter, which holds a film cartridge or a filmstrip, is loaded in the film scanner.

2. Description of the Related Art

Recently, as personal computers become widespread, photographic images are captured (read) by a digital camera or an image scanner to generate image data, and a personal computer is used for processing or recording the image data. There has been a demand in recent years for images formed on silver-salt photographic film to be read directly from the film. In order to meet this demand, various film scanners which can directly scan photographic film such as silver-salt film so that a personal computer can read image data of the film have been proposed. Such film scanners include those for APS (Advanced Photo System) film or conventional 35 mm film. When APS film is scanned, an APS film adapter in which an APS cartridge has been loaded is loaded in the film scanner. After the APS film adapter is properly loaded in the film scanner, film is drawn out of the APS cartridge so that images on one or more desired frames of the film are read by scanning operation. On the other hand, when 35 mm film is scanned, firstly a filmstrip including a predetermined number of frames, which is cut from of a roll of 35 mm film in advance, is held by a 35 mm film holder, and subsequently the 35 mm film holder is loaded in the film scanner so that images on one or more desired frames of the filmstrip are read by scanning operation.

In either of the above two film types (APS film or 35 mm film), when loaded in the film scanner, the APS film adapter or the 35 mm film holder is generally inserted into a moving table disposed in the film scanner. The moving table is driven to move in a sub-scanning direction (i.e., in a direction orthogonal to a main scanning direction). Such an operation of inserting the APS film adapter or the 35 mm film holder into the moving table so that it is mounted on the moving table needs to be performed manually by an operator of the film scanner.

In film scanners having such structure, it is important that the APS film adapter or the 35 mm film holder be properly loaded in or removed from the moving table. For instance, it is sometimes the case that the APS film adapter or the 35 mm film holder is inserted into the moving table from the opposite side (wrong side) thereof by mistake. In this case, the APS film adapter or the 35 mm film holder interferes with the moving table, and the interfering parts therebetween may be damaged. Moreover, the APS film adapter or the 35 mm film holder may become misaligned with respect to the moving table. Furthermore, a proper electrical connection may not be established between the APS film adapter and the film scanner in the case of the APS film adapter, or detecting markings formed on an end of the film adapter for identification of the film frame numbers, etc., may not be identifiable, in the case of the 35 mm film holder. This makes it impossible to read images of one or more desired frames of filmstrip. In addition, in the case of the 35 mm film holder, it is often the case that the 35 mm film holder is inserted into the moving table upside-down by mistake. In this case, the film scanner will read inversed images. Likewise, in the case of the APS film adapter, the APS film adapter may be accidentally taken out of the film scanner with some film remaining outside the APS cartridge. In this case, there is a possibility of the film being damaged since one or more frames of APS film are exposed to the outside the APS film adapter.

### SUMMARY OF THE INVENTION

The present invention provides a film scanner capable of preventing the above-described misoperations from occurring when an APS film holder or a conventional film adapter such as a 35 mm film adapter is loaded in or removed from the film scanner, thus making it possible to read images formed on frames of film while preventing film and other parts from being damaged.

According to an aspect of the present invention, a film scanner is provided, including a film holding device for holding a film to be scanned, an image pick-up device for scanning an image on the film in a main scanning direction, and a moving table having the film holding device mounted thereon, the moving table being movable with respect to the image pick-up device in a sub-scanning direction. The moving table includes an insertion portion into which the film holding device is inserted to be mounted on the moving table, the insertion portion allowing the film holding device to be inserted into the insertion portion only from a predetermined side of the moving table, and an insertion prevention device for preventing the film holding device from being inserted into the insertion portion in a position other than a predetermined position.

It is desirable for the film holding device to include a portion having a vertically asymmetrical cross section taken along a plane orthogonal to a direction of insertion of the film holding device into the insertion portion.

It is desirable for the film holding device to include a groove extending parallel to the insertion direction at a position away from a center-line of the film holding device parallel to the insertion direction, and for the insertion prevention device to include an insertion prevention projection on the insertion portion which is inserted into the groove when the film holding device is inserted in a correct position.

It is desirable for the film holding device to include a projection at a position away from a center line of the film holding device parallel to the insertion direction, and for the insertion prevention device to include a stop projection formed in the insertion portion at a position to interfere with the projection of the film holding device when the film holding device is inserted into the insertion portion from a side thereof opposite to the predetermined side of the insertion portion with respect to the center line.

The moving table can include a film-holding-device moving mechanism using a motor for moving the film holding device in the moving table, the film scanner can further include a controller for controlling an electrical current passing through the motor of the film-holding-device moving mechanism, and the controller can control the electrical current to produce a torque for holding the motor which is greater than a torque necessary for the film holding device to be pulled out from the insertion portion.

The film holding device can serve as a film holder which holds a filmstrip cut out of a roll film and exposes the image of the film through a frame like aperture.

The film holding device can serve as a film adapter which accommodates a cartridge containing a roll film and includes a mechanism for winding out film from the cartridge so that one frame is exposed through an aperture formed on the film holding device.

The film adapter can include an APS film a dapter which accommodates an APS cartridge containing an APS film and winds out the APS film from the APS cartridge to expose a requested image through the aperture. The controller passes an electrical current through the motor to produce a torque for holding the motor in a state where at least a part of APS film is wound out from the APS cartridge with the APS film adapter.

It is desirable for the film scanner to further include a guiding mechanism for guiding the moving table in the sub-scanning direction, and a motor for moving the moving table in the sub-scanning direction.

The insertion portion can have a T-shaped cross section in a plane orthogonal to a direction of movement of the moving table.

It is desirable for the film holding device to include a rack which is engaged with a pinion of the motor when the film holding device is inserted into the insertion portion of the moving table.

The film holding device can further include a first array of contacts which respectively come into contact with a second array of contacts formed on the film scanner when the film holding device is inserted into the insertion portion, the controller passing the electrical current through the motor via the first array of contacts and the second array of contacts.

In another embodiment, a film scanner is provided, including a film holding device for holding film to be scanned, an image pick-up device for scanning the film in a main scanning direction, a moving table guided in a sub-scanning direction orthogonal to the main scanning direction, the film holding device being inserted into the moving table with the film being held by the film holding device, and a driving system for driving the moving table in the sub-scanning direction with respect to the image pick-up device. The moving table can include a chamber into which the film holding device is inserted to be mounted on the moving table, the chamber allowing the film holding device to be inserted into the chamber only from a predetermined side thereof, and an insertion prevention device for preventing the film holding device from being inserted into the chamber from a side other than the predetermined side.

The present disclosure relates to subject matter contained in Japanese Patent Application No. 2002-87892 (filed on Mar. 27, 2002) which is expressly incorporated herein by reference in its entirety.

### BRIEF DESCRIPTION OF THE DRAWINGS

The present invention will be described below in detail with reference to the accompanying drawings in which:

FIG. 1A is a perspective view of fundamental elements of an embodiment of a film scanner according to the present invention;

FIG. 1B is a perspective view of an embodiment of an APS film adapter for the film scanner shown in FIG. 1A;

FIG. 2 is a plan view of a fundamental portion of the film scanner shown in FIG. 1A;

FIG. 3 is a side elevational view of the fundamental portion of the film scanner shown in FIG. 2;

FIG. 4 is a cross sectional view taken along IV-IV line shown in FIG. 1A;

FIG. 5A is a perspective view of fundamental elements of the film scanner shown in FIG. 1A, as viewed from a different angle;

FIG. 5B is a perspective view of the APS film adapter shown in FIG. 1B, as viewed from a different angle;

FIG. 6 is a perspective view of a 35 mm film holder which is used for the film scanner shown in FIG. 1A, showing a state where a film holding plate of the 35 mm film holder is closed;

FIG. 7 is a perspective view of the 35 mm film holder shown in FIG. 6, as viewed from a different side thereof, showing a state where the film holding plate is open;

FIG. 8 is an exploded perspective view of a movable contact portion of the film scanner shown in FIG. 1A;

FIG. 9 is a block diagram illustrating fundamental electrical components of the film scanner shown in FIG. 1A;

FIG. 10A is a view similar to that of FIG. 4 and shows a state where the 35 mm film holder shown in FIG. 6 is inserted into the film scanner;

FIG. 10B is a view similar to that of FIG. 4 and shows a state where the APS adapter shown in FIG. 5 is inserted into the film scanner;

FIG. 11 is a flow chart illustrating a main process of the film scanner;

FIG. 12 is a flow chart illustrating a subroutine “Film Holder” shown in FIG. 11;

FIG. 13 is a flow chart illustrating a subroutine “APS Adapter” shown in FIG. 11; and

FIG. 14 is a flow chart illustrating a subroutine “Removal Prevention” shown in FIG. 11.

### DESCRIPTION OF THE PREFERRED EMBODIMENT

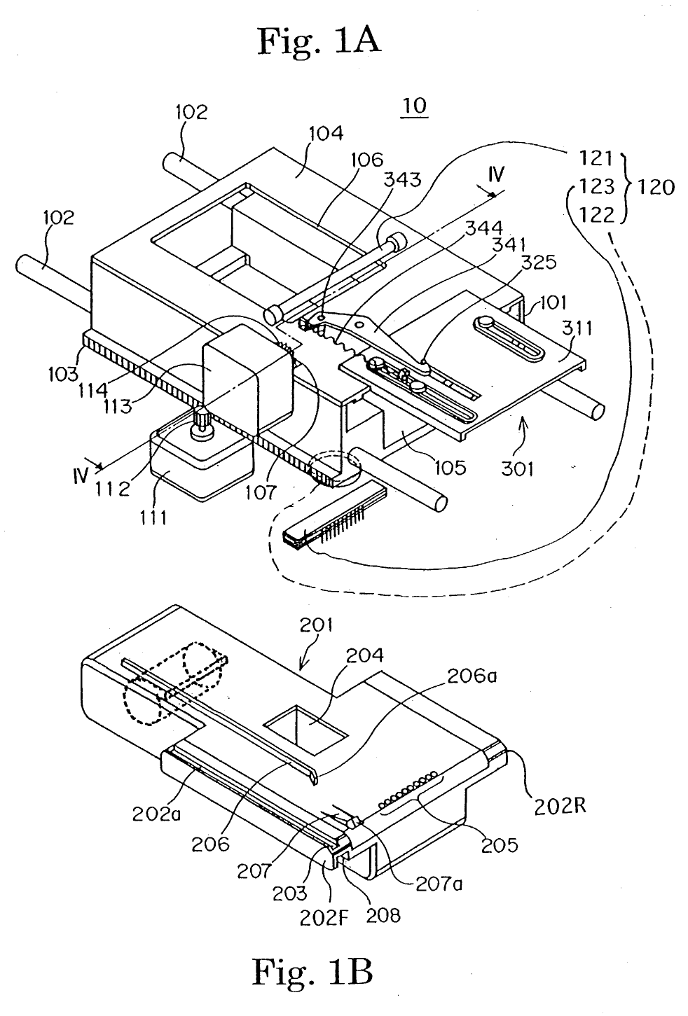

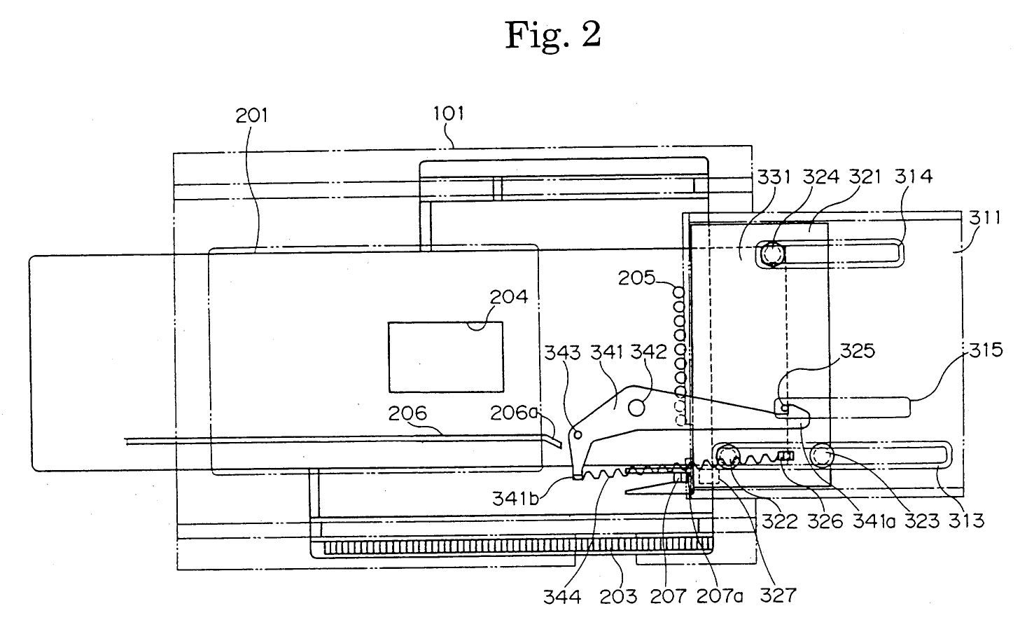

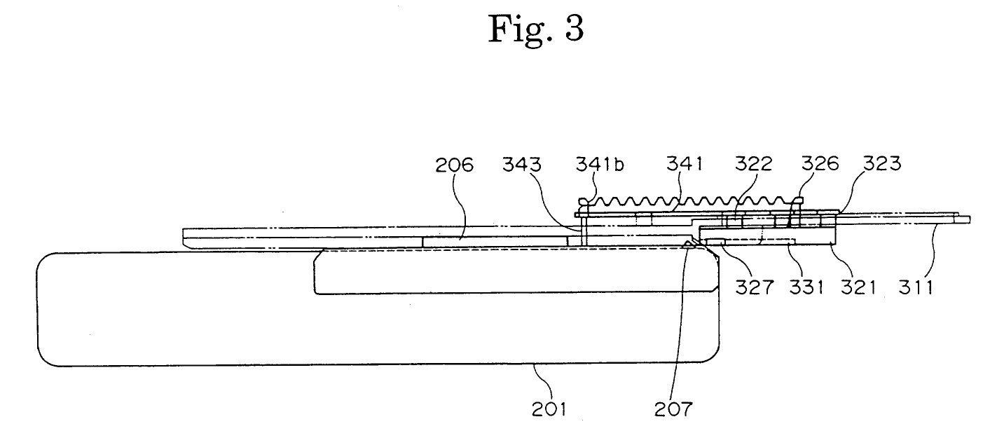

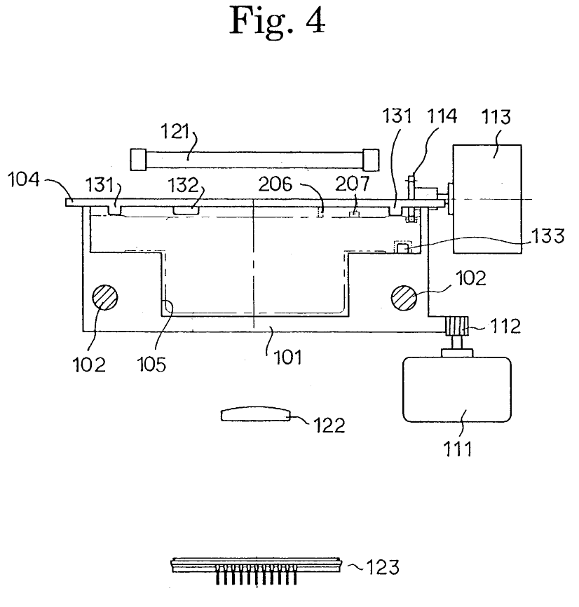

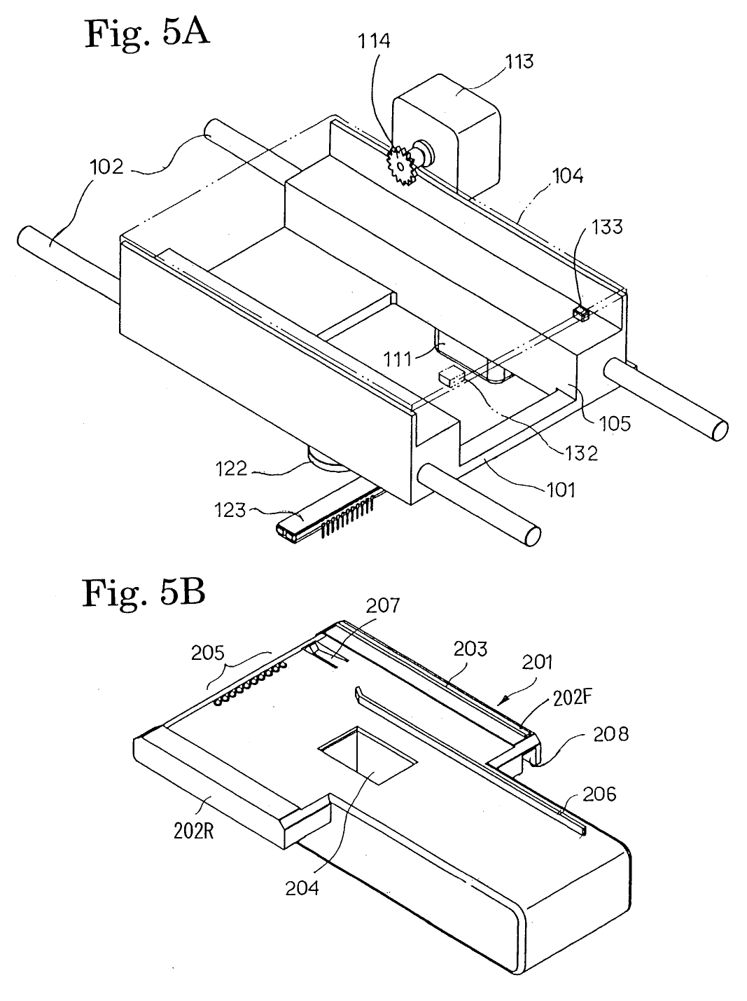

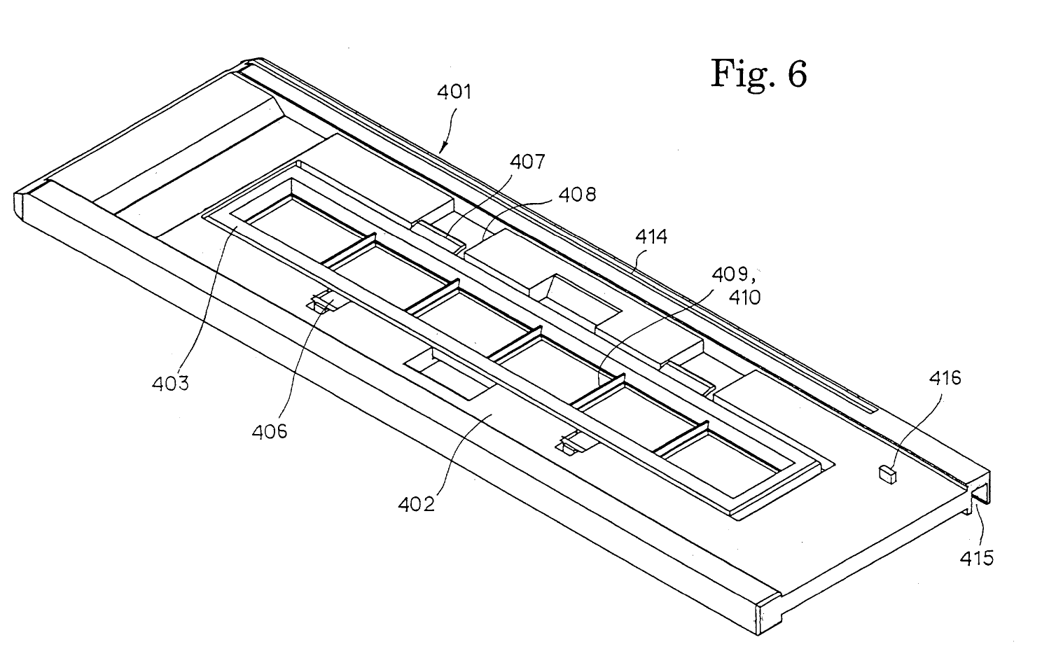

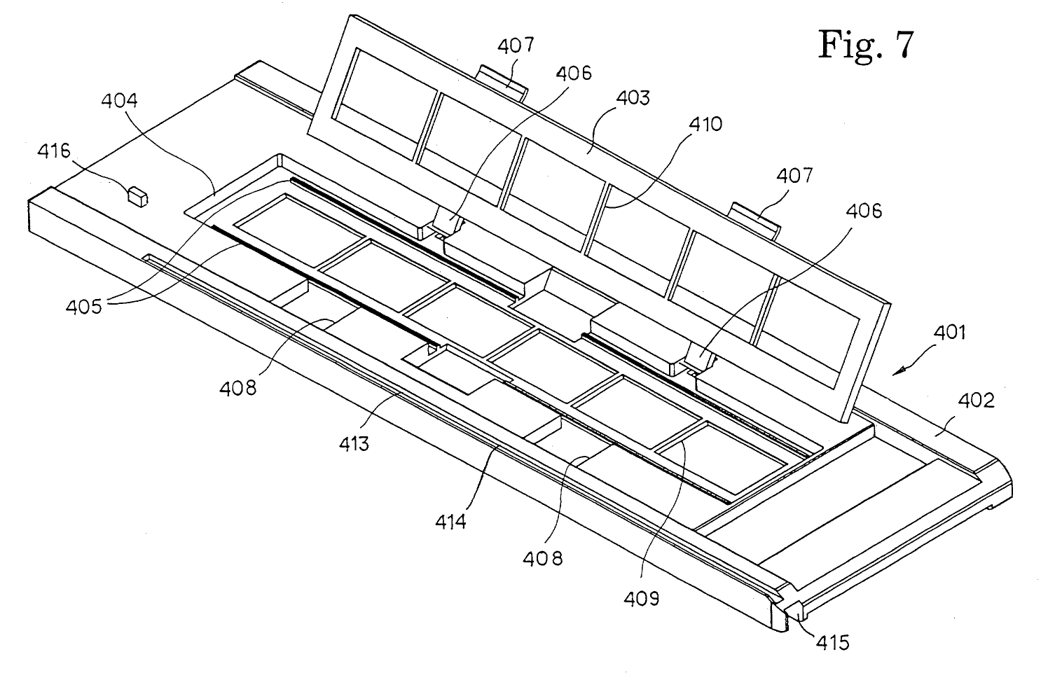

FIG. 1A shows fundamental elements of an embodiment of a film scanner 10 according to the present invention. The film scanner 10 recognizes 35 mm filmstrip incorporated in a 35 mm film holder 401 (see FIGS. 6 and 7), or APS film with an APS adapter (see FIGS. 1B and 5B) 201. The film scanner 10 is provided with a pair of parallel guide shafts (guiding mechanism) 102 extending in a horizontal direction. The pair of parallel guide shafts 102 are positioned in a housing (not shown) of the film scanner 10, and the respective ends of each parallel guide shaft 102 are fixed to the housing. The film scanner 10 is provided on the pair of parallel guide shafts 102 with a moving table 101 which is movable along the pair of parallel guide shafts 102. Specifically, the pair of parallel guide shafts 102 penetrate through the moving table 101 so that the opposite ends of each guide shaft 102 project in opposite directions from opposite end surfaces of the moving table 101. Accordingly, the moving table 101 can move forward and reverse along the pair of parallel guide shafts 102 while sliding thereon at the penetrated portions of the moving table 101. The moving table 101 is provided on one side thereof along the direction of movement of the moving table 101 with a rack 103 which is engaged with a pinion 112 fixed on a rotating shaft of a main scanning motor 111 provided in the housing of the film scanner 10. The main scanning motor 111 is a stepper motor. Forward and reverse rotations of the pinion 112 of the main scanning motor 111 cause the moving table 101 to move forward and reverse along the pair of parallel guide shafts 102, respectively, due to engagement of the pinion 112 with the rack 103. A top plate 104 is fixed to the moving table 101 to fully cover the top of the moving table 101. With the top plate 104, a chamber (insertion portion) 105 (see FIG. 4) having a T-shaped cross section in a plane orthogonal to the direction of movement of the moving table 101 is formed in the moving table 101. Either the APS film adapter 201 or the 35 mm film holder 401 can be manually inserted into and removed from the chamber 105 from the left side as viewed in FIG. 2.

A pre-scanning motor 113 is fixed to one side of the moving table 101. The pre-scanning motor 113 is a stepper motor. A pinion 114 fixed on a rotating shaft of the pre-scanning motor 113 is exposed to the inside of the chamber 105 through a cutout 107 formed on the top plate 104 to be engageable with a rack 203 formed on the APS film adapter 201 or a rack 414 formed on the 35 mm film holder 401. The main scanning motor 111, the pinion 112, the rack 103, the pre-scanning motor 113 and the pinion 114 constitute a driving system for driving the moving table 101 in the sub-scanning direction. Furthermore, the pre-scanning motor 113, the pinion 114, and the rack 203 or rack 414 constitute a film-holding-device moving mechanism.

The top plate 104 is provided with a rectangular scanning aperture 106 through which the chamber 105 is exposed to the upper side of the top plate 104. As shown in FIGS. 1A and 4, the film scanner 10 is provided above the scanning aperture 106 with a fluorescent lamp 121 serving as a light source of the film scanner 10, and is further provided, under the moving table 101 directly below the fluorescent lamp 121, with an image pick-up lens 122 and a CCD line sensor (image pick-up device) 123 which converts images of film converged onto the CCD line sensor 123 via the image pick-up lens 122 into electrical signals. The fluorescent lamp 121, the image pick-up lens 122 and the CCD line sensor 123 constitute a scanning device 120. The CCD line sensor 123 is positioned to extend in a direction orthogonal to a longitudinal direction of each guide shaft 102 to scan over film in a main scanning direction. In this illustrated embodiment of the film scanner 10, the CCD line sensor 123 is constructed as a color CCD line sensor, which can scan an image in each primary color (red, green and blue).

The APS film adapter 201 is formed as an elongated box which is provided on respective sides thereof with two overhangs 202F and 202R projecting in opposite directions. The APS film adapter 201 can be inserted into and removed from the chamber 105 of the moving table 101 from the left side thereof as viewed in FIG. 2 along the direction of movement of the moving table 101. The APS film adapter 201 is provided on a top surface of the overhang 202F along a longitudinal direction of the APS film adapter 201 with a groove 202a, and is further provided on bottom of the groove 202a with the rack 203 which is engageable with the pinion 114 of the pre-scanning motor 113. The overhang 202F is provided on a bottom surface thereof with a groove 208 having a U-shaped cross section which extends along the length of the overhang 202F. It should be noted that no groove corresponding to the groove 208 is formed on a bottom surface of the other overhang 202R. The APS film adapter 201 is provided at an approximate center thereof with a rectangular aperture 204 which penetrates through the APS film adapter 201 in a vertical direction thereof. A plan view of the rectangular aperture 204 substantially corresponds to one frame of APS film. The APS film adapter 201 is provided on a top front surface thereof with an array of electrical contacts 205 aligned in a direction orthogonal to the longitudinal direction of the APS film adapter 201. Each electrical contact of the contact array 205 is in the shape of a hemisphere, and resiliently projects from the top surface of the APS film adapter 201. The APS film adapter 201 is further provided on top thereof with an engagement release cam 206, and a resilient engaging leaf 207 having a claw portion 207a at a free end thereof. The engagement release cam 206 is formed as an elongated wall perpendicular to the top surface of the APS film adapter 201. As shown in FIG. 2, the major part of the engagement release cam 206 extends in an inserting/removing direction (i.e., longitudinal direction) of the APS film adapter 201 while a front end portion (right end portion as viewed in FIG. 2) 206a of the engagement release cam 206 slightly bends toward the overhang 202F side (downwards as viewed in FIG. 2). The resilient engaging leaf 207 is formed on a top wall of the APS film adapter 201 by cutting out a substantially U-shaped piece from the top wall to be resiliently deformable in an upward direction from the top wall. The claw portion 207a projects upwards from the free end of the resilient engaging leaf 207. Although not shown in the drawings, an APS cartridge containing APS roll film is loaded in the APS film adapter 201 so that a frame of frames developed on the film can be selectively exposed to the outside of the APS film adapter 201 through the rectangular aperture 204 by driving the loaded APS cartridge by an internal film feeding motor (not shown) provided in the APS film adapter 201. Electrical power for driving the internal motor is supplied thereto from an external power supply (not shown) via the contact array 205.

As shown in FIGS. 6 and 7, the 35 mm film holder 401 is provided with a base plate 402 and a film holding plate 403 which is rotatably connected to the base plate 402 via two hinge portions 406. After a 35 mm filmstrip including six frames (hereinafter referred to as simply “filmstrip”) is placed on the base plate 402 with the film holding plate 403 open, the film holding plate 403 is closed so that the filmstrip is held (sandwiched) between the base plate 402 and the film holding plate 403. The base plate 402 is provided thereon with an elongated film mounting recess 404 having a shallow depth in which the filmstrip is placed. The film holding plate 403 is formed to be substantially the same as the film mounting recess 404 in shape and size, and is provided on an edge thereof at two separate points on the edge with the two hinge portions 406 so that the film holding plate 403 can be opened and closed via the hinge portions 406. The film holding plate 403 is provided, along an edge thereof opposite to the edge having the two hinge portions 406, with two engaging protrusions 407, while the base plate 402 is provided on top thereof along a corresponding edge of the film mounting recess 404 with two engaging recesses 408 in which the two engaging protrusions 407 can be engaged. When the film holding plate 403 is closed as shown in FIG. 6, the two engaging protrusions 407 are engaged in the two engaging recesses 408, respectively, to fix the film holding plate 403 to the base plate 402. The base plate 402 is provided with a series of six rectangular apertures 409 formed to correspond to six frames of the filmstrip which is to be held between the base plate 402 and the film holding plate 403, and the film holding plate 403 is provided with a corresponding series of six rectangular apertures 409 having the same shape and size as the six rectangular apertures 409. The base plate 402 is provided, on a bottom surface of the film mounting recess 404 on opposite sides of the series of six rectangular apertures 409, with a pair of guide rails 405, respectively, for guiding the associated opposite edges of the filmstrip. The filmstrip is placed on a bottom surface of said film mounting recess 404 between the pair of guide rails 405 when the filmstrip is held between the base plate 402 and the film holding plate 403.

The base plate 402 is provided on top thereof, along one of the two long sides of the base plate 402, with a groove 413. The rack 414, which is engagable with the pinion 114 of the pre-scanning motor 113 which is supported by the moving table 101, is formed on a bottom surface of the groove 413. The base plate 402 is provided on a bottom surface thereof below the groove 413 with a groove 415 having a U-shaped cross section which extends along the length of the base plate 402. The groove 415 has the same specifications as the groove 208 of the APS film adapter 201. The base plate 402 is provided on top thereof in the vicinity of one of the two short sides of the base plate 402 with an engaging projection 416 positioned to correspond to the engagement release cam 206.

As shown in FIG. 4, the top plate 104 is provided on an inner surface thereof with a pair of parallel guide projections 131 which are elongated in the direction of movement of the moving table 101. The pair of parallel guide projections 131 are positioned to face the two overhangs 202F and 202R of the APS film adapter 201 when the APS film adapter 201 is inserted into the chamber 105. The pair of parallel guide projections 131 slidably contact the top surface of the APS film adapter 201 to define the vertical position of the APS film adapter 201 with respect to the top plate 104 when the APS film adapter 201 moves in the chamber 105. Likewise, the pair of parallel guide projections 131 slidably contact the top surface of the 35 mm film holder 401 to define the vertical position of the 35 mm film holder 401 with respect to the top plate 104 when the 35 mm film holder 401 moves in the chamber 105. The top plate 104 is provided on an inner surface thereof between the pair of parallel guide projections 131 with a stop projection (insertion prevention projection) 132 which extends downwards in the chamber 105. The stop projection 132 is formed at a position to interfere with the engagement release cam 206 and the engaging projection 416 when the APS film adapter 201 and the 35 mm film holder 401 are inserted into the chamber 105 of the moving table 101 from the opposite side of the chamber 105, respectively. Namely, the stop projection 132 prevents each of the APS film adapter 201 and the 35 mm film holder 401 from being inserted into the chamber 105 from the opposite side (wrong side) thereof (from the left side of FIG. 5A). In addition, as shown in FIGS. 4 and 5A, the moving table 101 is provided on a bottom surface thereof above one of the pair of parallel guide shafts 102 with a stop projection (insertion prevention projection) 133 which extends upwards in the chamber 105. The stop projection 133 is shaped and formed at a position not to interfere with the groove 208 of the APS film adapter 201 and the groove 415 of the 35 mm film holder 401 when the APS film adapter 201 and the 35 mm film holder 401 are inserted into the chamber 105 of the moving table 101 in the correct direction from the insertion side of the moving table 101 (from the right side of FIG. 5A), respectively. Accordingly, the stop projection 133 also prevents each of the APS film adapter 201 and the 35 mm film holder 401 from being inserted into the chamber 105 from the opposite side thereof (from the left side of FIG. 5A). The stop projections 132 and 133 constitute an insertion prevention device.

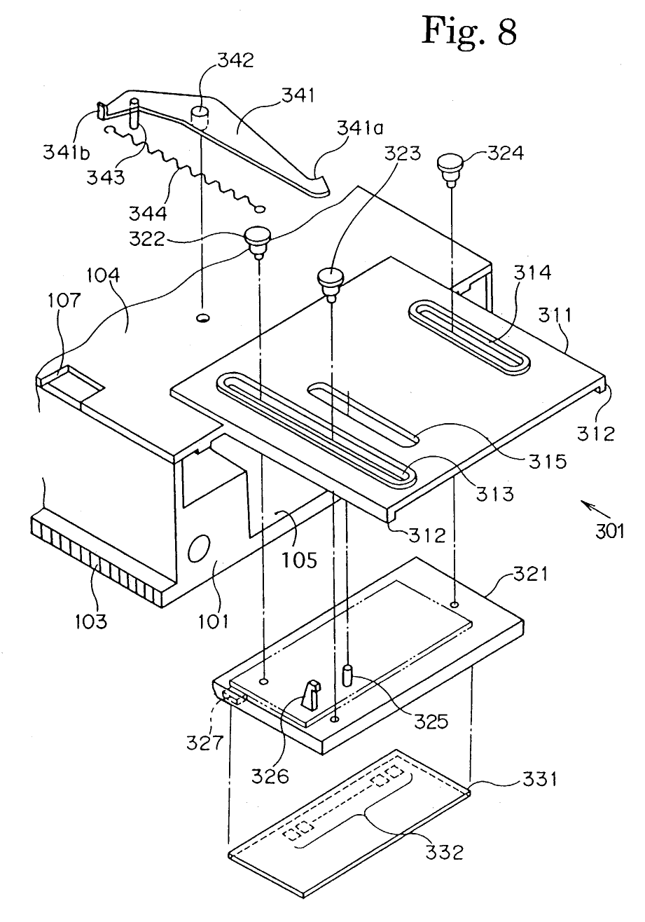

The film scanner 10 is provided with a movable contact portion 301 which is fixed to the top plate 104 of the moving table 101. The movable contact portion 301 is electrically connected to the contact array 205 of the APS film adapter 201 when the APS film adapter 201 is inserted into the chamber 105 of the moving table 101. FIG. 8 shows an exploded perspective view of the movable contact portion 301. The movable contact portion 301 is provided on the insertion side of the chamber 105 with a guide plate 311 which is formed integral with the top plate 104 to extend parallel to the top plate 104 and project away from the insertion side of the chamber 105 in a direction opposite to the insertion direction. Opposite side edges 312 of the guide plate 311 bend downwards to support a board holder 321 therebetween. A contact board 331 is fixed to a bottom surface of the board holder 321. The contact board 331 is provided on a bottom surface thereof with an array of electrical contacts 332 which can come into contact with the array of electrical contacts 205, respectively. A flexible printed wiring board (not shown) is connected to the contact array 332 so that electrical power supplied from an external power supply and control signals for controlling the internal film feeding motor are supplied thereto via the flexible printed wiring board.

The guide plate 311 is provided with first and second guide slots 313 and 314, and a slot 315 positioned between the first and second guide slots 313 and 314. These three slots 313, 314 and 315 extend parallel to one another in an inserting/removing direction, i.e., in a direction parallel to the pair of parallel guide shafts 102. Two guide pins 322 and 323, each of which is formed as a stepped pin having a large-diameter head, are inserted into the first guide slot 313 from above the guide plate 311, and respective tips of the two guide pins 322 and 323 are fixed to the board holder 321. Likewise, a guide pin 324, which is formed as a stepped pin having a large-diameter head, is inserted into the second guide slot 314 from above the guide plate 311, and a tip of the guide pin 324 is fixed to the board holder 321. The guide pins 322 and 323 can move along the first guide slot 313 therein while the guide pin 324 can move along the second guide slot 314 therein. With this structure, the board holder 321 is movable on a bottom surface of the guide plate 311 while being guided along the first and second guide slots 313 and 314. The board holder 321 is provided thereon with an engaging pin 325 which penetrates through the guide plate 311 through the slot 315 to extend upwards from the top surface of the guide plate 311. The board holder 321 is further provided thereon between the two guide pins 322 and 323 with a spring-hook projection 326 which penetrates the guide plate 311 through the first guide slot 313 to extend upwards from the top surface of the guide plate 311. The board holder 321 is provided on a bottom surface thereof in the vicinity of a side edge of the board holder 321 with an engaging recess 327 which is engageable with the claw portion 207a of the resilient engaging leaf 207 of the APS film adapter 201.

An engagement/release lever 341 is pivoted about a pin 342 which projects upwards from the top plate 104 of the moving table 101, so that the engagement/release lever 341 is rotatable about the pin 342 in a horizontal plane. The engagement/release lever 341 is provided at opposite ends thereof with an engaging claw portion 341a and a spring-hook portion 341b, respectively. The engagement/release lever 341 is provided in the vicinity of the spring-hook portion 341b with a release pin 343 which extends downwards. One end and the other end of an extension coil spring 344 are hooked on the spring-hook portion 341b and the spring-hook projection 326, respectively, to always bias the engagement/release lever 341 to rotate counterclockwise as viewed in FIG. 2. The release pin 343 is positioned on a path of the engagement release cam 206 of the APS film adapter 201. The engaging claw portion 341a is situated at a position to be engageable with the engaging pin 325 of the board holder 321.

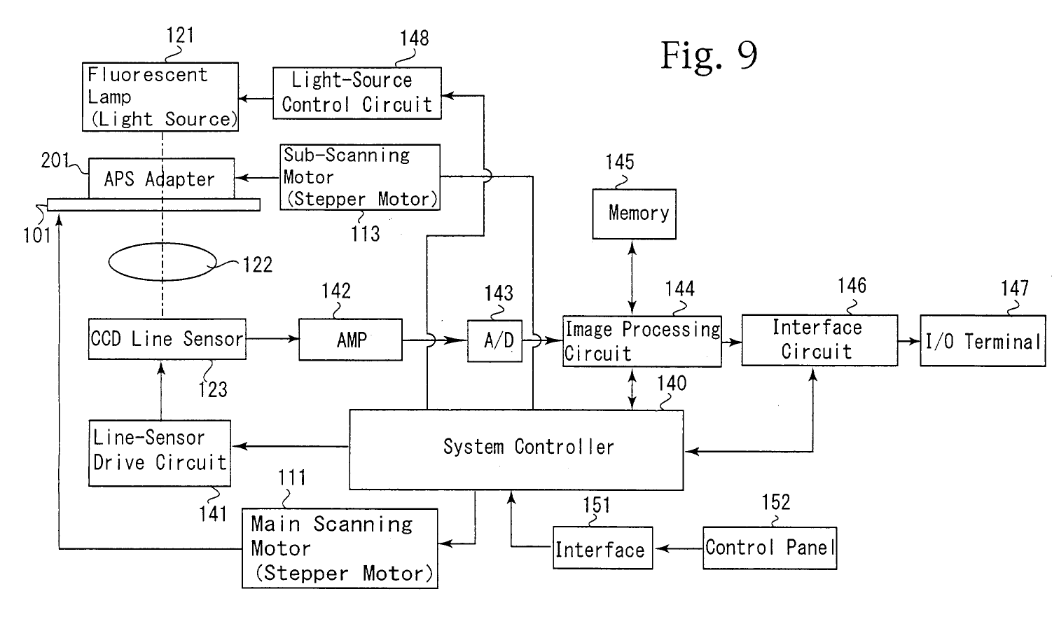

FIG. 9 is a block diagram illustrating fundamental elements of an electrical circuit of the film scanner 10. The CCD line sensor 123 is driven by a line-sensor drive circuit 141 which is controlled by a system controller 140. An analogue signal output from the CCD line sensor 123 is amplified by an amplifier 142 to be converted into a digital signal. Subsequently, the digital signal is subjected to image processing in an image processing circuit 144 to be output as an image signal (image data) from the image processing circuit 144. A memory 145 that is connected to the image processing circuit 144 stores the image signal output from the image processing circuit 144. The memory 145 can be an IC card. The image signal output from the image processing circuit 144 is also output to an I/O terminal 147 via an interface circuit 146 to be input to electronic equipment (not shown) such as a personal computer. Light emission of the fluorescent lamp 121 is controlled by a light-source control circuit 148 which is controlled by the system controller 140. The system controller 140 is connected to a control panel 152 via an interface 151. The main scanning motor 111 and the pre-scanning motor 113 are connected to the system controller 140 so that the respective rotations thereof are controlled by the system controller 140.

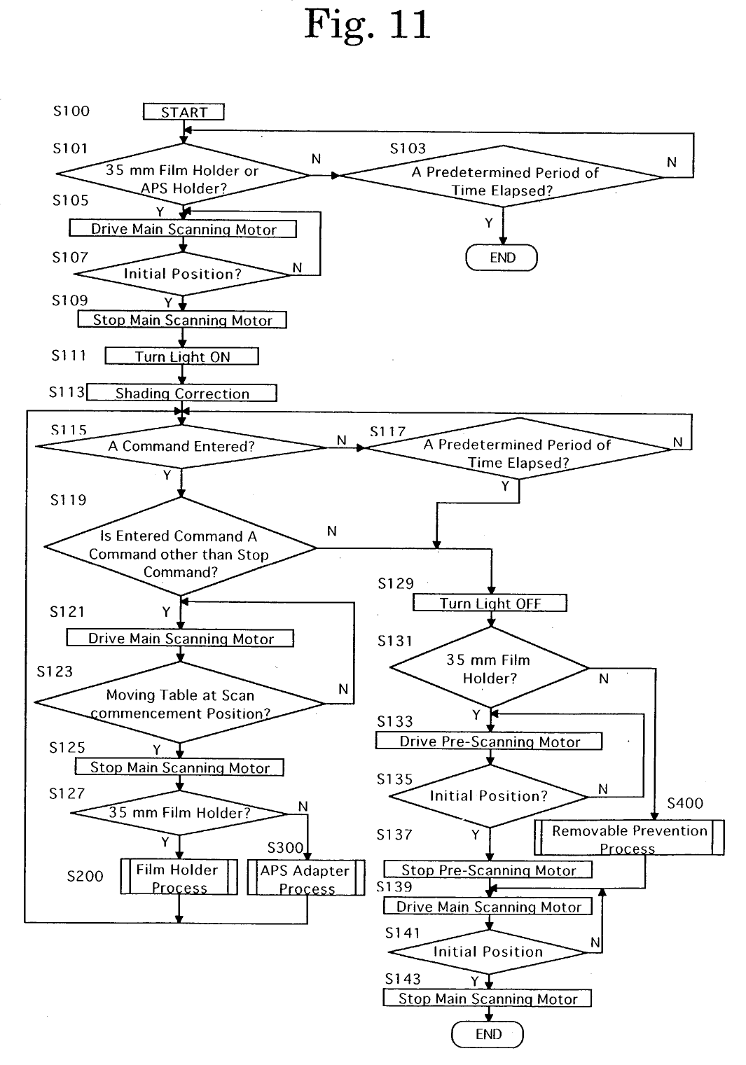

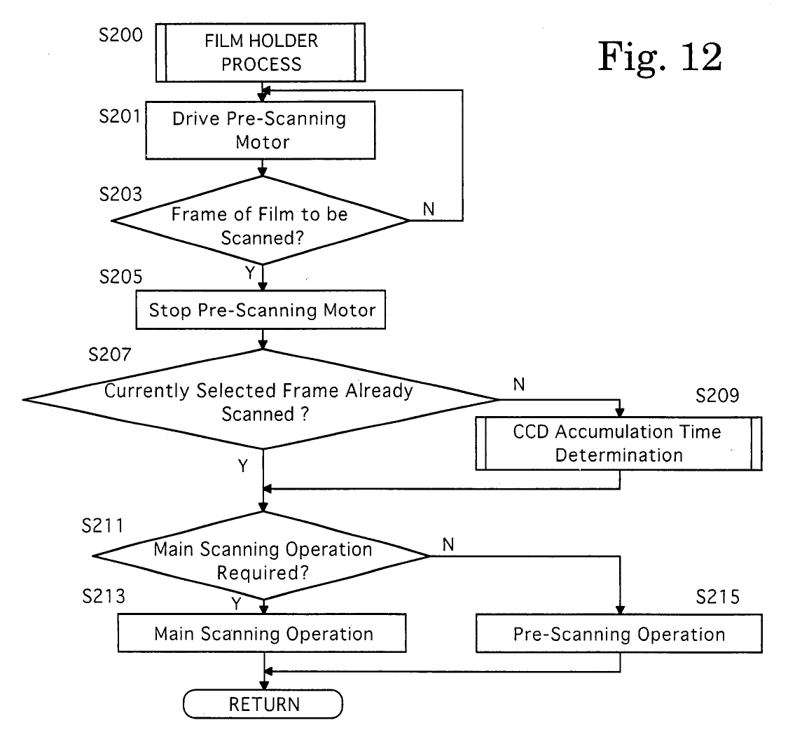

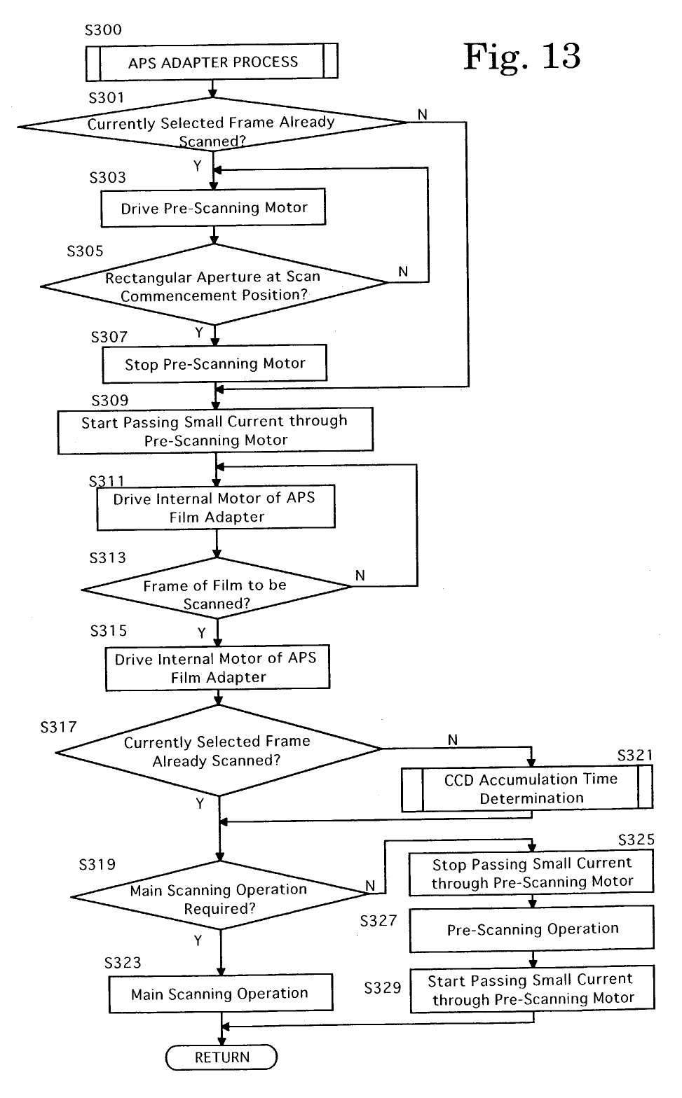

A main process of the film scanner 10 will be hereinafter discussed with reference to the flow chart shown in FIG. 11. Immediately after the power of the film scanner 10 is turned ON (step S100), it is determined whether the APS film adapter 201 or the 35 mm film holder 401 is inserted in the moving table 101 (step S101). If it is determined that neither the APS film adapter 201 nor the 35 mm film holder 401 is inserted in the moving table 101, control proceeds to step S103 at which it is determined whether a predetermined period of time has elapsed. If the predetermined period of time has not yet elapsed, control returns to step S101. If the predetermined period of time has elapsed, control ends the main process. If it is determined at step S101 that the APS film adapter 201 or the 35 mm film holder 401 is in the moving table 101, the main scanning motor 111 is driven to move the moving table 101 to an initial position thereof (step S105). Subsequently, it is determined whether the moving table 101 is at the initial position (step S107). if the moving table 101 is not yet at the initial position, control returns to step S105. If it is determined that the moving table 101 is at the initial position, the main scanning motor 111 is stopped (step S109). Subsequently, the fluorescent lamp 121 is turned ON (step S111) so that the CCD line sensor 123 receives light emitted from the fluorescent lamp 121 to perform a shading correction (step S113). Subsequently, it is determined whether a command has been entered (step S115). If no command has been entered, it is determined whether a predetermined period of time has elapsed (step S117). If NO at step S117, control returns to step S115. If YES at step S117, the fluorescent lamp 121 is turned OFF (step S129), and subsequently control enters a stop process which starts at step S131. If it is determined at step S115 that a command has been entered, it is determined whether the entered command is not a stop command (step S119). If the entered command is a stop command, the fluorescent lamp 121 is turned OFF (step S129), and subsequently control enters the stop process. If it is determined at step S119 that the entered command is not a stop command, i.e., the entered command is a command for performing a main scanning operation or a pre-scanning operation, the main scanning motor 111 is driven again to move the moving table 101 to a scan commencement position (step S121). Subsequently, it is determined whether the moving table 101 is positioned at the scan commencement position (step S123). If NO at step S123, control returns to step S121 to continue to drive the main scanning motor 111. If YES at step S123, the main scanning motor 111 is stopped (step S125). Subsequently, it is determined whether the APS film adapter 201 or the 35 mm film holder 401 is inserted in the chamber 105 of the moving table 101 (step S127). If the 35 mm film holder 401 is in the chamber 105, control enters a film holder process (first subroutine) shown in FIG. 12 (step S200). After the film holder process is performed, control returns to step S115. If the APS film adapter 201 is in the chamber 105, control enters an APS adapter process (second subroutine) shown in FIG. 13 (step S300). After the APS adapter process is performed, control returns to step S115. In each of the film holder process and the APS adapter process, a main scanning operation or a pre-scanning operation is performed to read the image on a frame of film. Thereafter, if it is determined at step S115 that the entered command is a stop command, the fluorescent lamp 121 is turned OFF (step S129), and subsequently control enters the aforementioned stop process to end the main process.

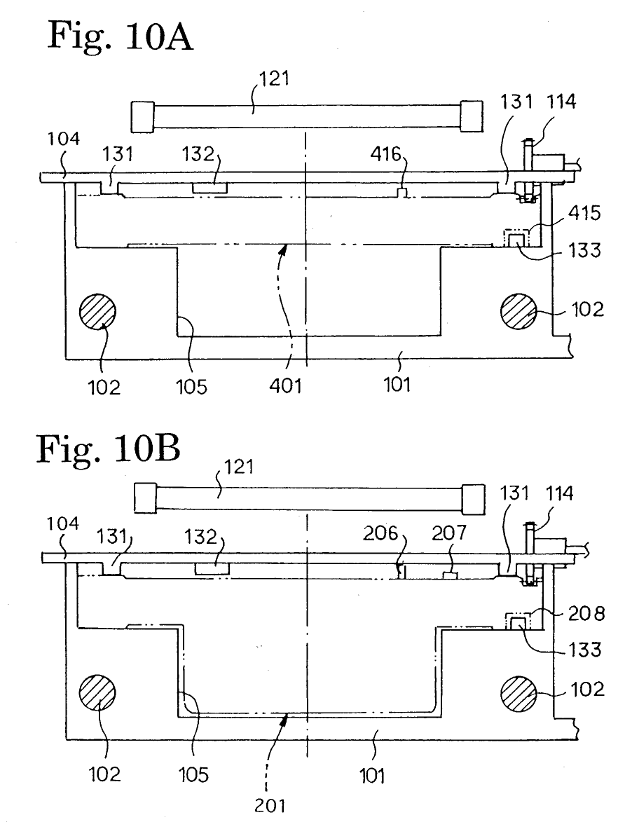

When the 35 mm film holder 401 is inserted into the moving table 101, the 35 mm film holder 401 is inserted into the chamber 105 from the predetermined end (left end as viewed in FIG. 2) thereof in a manner as shown in FIG. 10A, in which the 35 mm film holder 401 is shown by a two-dot chain line. At this time, the 35 mm film holder 401 can be inserted into the chamber 105 since the stop projection 133 is positioned in the groove 415 of the 35 mm film holder 401 while the engaging projection 416 of the 35 mm film holder 401 does not interfere with the stop projection 132 of the top plate 104 of the moving table 101. Even if someone tries to insert the 35 mm film holder 401 into the chamber 105 from the opposite end thereof mistakenly or deliberately, the 35 mm film holder 401 is prevented from being inserted into the chamber 105 since the stop projection 133 interferes with that side edge of the 35 mm film holder 401 which is provided with no groove like the groove 415 and the engaging projection 416 interferes with the stop projection 132. Likewise, the 35 mm film holder 401 is prevented from being inserted into the chamber 105 even if someone tries to insert the 35 mm film holder 401 into the chamber 105 upside down. Accordingly, the 35 mm film holder 401 is reliably prevented from being inserted into the chamber 105 when the 35 mm film holder 401 is not correctly inserted into the chamber 105. Consequently, the 35 mm film holder 401 and the moving table 101 can be prevented from interfering with each other, and hence from being damaged, or scanning of images of unselected frames can be prevented from occurring.

(0023)

Similar to the 35 mm film holder 401, when the APS film adapter 201 is inserted into the moving table 101, the APS film adapter 201 is inserted from the end thereof which has the contact array 205 into the chamber 105 from the predetermined end (left end as viewed in FIG. 2) thereof in a manner as shown in FIG. 10B, in which the APS film adapter 201 is shown by a two-dot chain line. At this time, the APS film adapter 201 can be inserted into the chamber 105 since the stop projection 133 is positioned in the groove 208 of the APS film adapter 201 and the engagement release cam 206 of the APS film adapter 201 does not interfere with the stop projection 132 of the top plate 104 of the moving table 101. Even if someone tries to insert the APS film adapter 201 into the chamber 105 from the opposite end thereof mistakenly or deliberately, the APS film adapter 201 is prevented from being inserted into the chamber 105 since the stop projection 133 interferes with the side edge of the APS film adapter 201 which is not provided with a groove like the groove 208, and at the same time, the engagement release cam 206 interferes with the stop projection 132. In the case of the APS film adapter 201, the APS film adapter 201 cannot be inserted into the chamber 105 upside down. Accordingly, the APS film adapter 201 is reliably prevented from being inserted into the chamber 105 when the APS film adapter 201 is not correctly inserted into the chamber 105. Consequently, the APS film adapter 201 and the moving table 101 can be prevented from interfering with each other, and hence from being damaged, or scanning of images of unselected frames can be prevented from occurring.

The film holder process at step S200, wherein the image on a frame of filmstrip held by the 35 mm film holder 401 inserted into the moving table 101 is read, will be hereinafter discussed with reference to the flow chart (first subroutine) shown in FIG. 12. In this process, firstly the pre-scanning motor 113 is driven to move the 35 mm film holder 401 which is inserted in the chamber 105 until a frame of the filmstrip which is to be scanned moves to a position corresponding to an optical axis of the scanning device 120 (step S201). Subsequently, it is determined whether the frame has moved to the position corresponding to the optical axis of the scanning device 120 (step S203). If the frame has not yet moved to the position corresponding to the optical axis of the scanning device 120, control returns to step S201 to continue to drive the pre-scanning motor 113. If the frame has already moved, the pre-scanning motor 113 is stopped (step S205), and subsequently it is determined whether the currently selected frame has been already scanned in the pre-scanning operation or main scanning operation (step S207). If the currently selected frame has been already scanned, it is determined whether the main scanning operation is required (step S211). If it is determined at step S211 that the main scanning operation is required to be performed with the CCD accumulation time, the main scanning operation is performed (step S213), and subsequently control returns to the main process shown in FIG. 11. If it is determined at step S211 that the main scanning operation is not required to be performed with the CCD accumulation time, the pre-scanning operation is performed (step S215) and subsequently control returns to the main process shown in FIG. 11. If it is determined at step S207 that the currently selected frame has not yet been scanned in the pre-scanning operation at step S215, a CCD accumulation time determination process is performed to acquire the CCD accumulation time (step S209), subsequently it is determined whether the main scanning operation is required to be performed with a CCD accumulation time (i.e., time necessary for the CCD image sensor 123 to accumulate electric charges) which has been determined in a CCD accumulation time determination process at step S209 (step S211). In the main scanning operation at step S213, the main scanning motor 111 rotates in a forward direction, stops, rotates in a reverse direction and stops in this particular order, which causes the pinion 112 of the main scanning motor 111 to rotate to thereby move the moving table 101, which has the rack 103 engaged with the pinion 112, along the pair of parallel guide shafts 102. During such movement of the moving table 101, the currently selected frame is illuminated by the fluorescent lamp 121 so that the image on frame of filmstrip is formed on the CCD line sensor 123 via the image pick-up lens 122 to be scanned in the main scanning direction by the CCD line sensor 123 while being scanned in the sub-scanning direction due to the movement of the moving table 101. The CCD line sensor 123 scans an image in each of primary color (red, green and blue).

In the pre-scanning operation at step S215, in which the image on a frame of filmstrip is scanned coarsely, the sub-scanning motor 113 rotates in a forward direction, stops, rotates in a reverse direction and stops in this particular order, which causes the pinion 114 of the sub-scanning motor 113 to rotate to thereby move the 35 mm film holder 401, which has the rack 414 engaged with the pinion 114, in the chamber 105 of the moving table 101. During such movement of the 35 mm film holder 401, the currently selected frame is illuminated by the fluorescent lamp 121 so that the image on the frame is formed on the CCD line sensor 123 via the image pick-up lens 122 to be scanned in the main scanning direction by the CCD line sensor 123 while being scanned in the sub-scanning direction due to the above described movement of the 35 mm film holder 401, similar to the main scanning operation. Similar to the main scanning operation, the CCD line sensor 123 scans an image in each primary color (red, green and blue) in the pre-scanning operation. Since the pre-scanning motor 113 is driven to rotate in larger steps than the main scanning motor 111, each frame of filmstrip is scanned by the CCD line sensor 123 at large steps in the sub-scanning direction. Accordingly, the pre-scanning operation consumes less time than the main scanning operation to complete the reading of the image on a frame of filmstrip. The pre-scanning operation is performed before the main scanning operation is performed to roughly check the contents of the image on a frame of filmstrip, the density of the image, and an area of the image which will be scanned in the main scanning operation.

The APS adapter process at step S300, wherein the image on a frame of APS film in the APS cartridge loaded in the APS film adapter 201 is read, will be hereinafter discussed with reference to the flow chart (second subroutine) shown in FIG. 13. In this process, firstly it is determined whether the currently selected frame of APS film has been already scanned (step S301). If it is determined at step S301 that the currently selected frame has not yet been scanned, the pre-scanning motor 113 is driven so that the rectangular aperture 204 that penetrates through the APS film adapter 201 moves to a predetermined scan commencement position (step S303). Subsequently, it is determined whether the rectangular aperture 204 is positioned at the scan commencement position (step S305). If NO at step S305, control returns to step S303 to continue to drive the pre-scanning motor 113. If YES at step S305, the pre-scanning motor 113 is stopped (step S307). In the operations at steps S303 through S307, in a state where the APS film adapter 201 has been inserted into the chamber 105, the pre-scanning motor 113 is driven to move the APS film adapter 201 in the chamber 105 so that the rectangular aperture 204 of the APS film adapter 201 lies at a predetermined position relative to the rectangular aperture 204. At this time, the array of electrical contacts 205 are in contact with the array of electrical contacts 332, respectively, to establish electrical connection therebetween.

Subsequently, the system controller 140 starts passing a small electrical current through the pre-scanning motor 113 until the pre-scanning motor 113 is charged, but not to the extent wherein the pre-scanning motor 113 starts rotating (step S309). Subsequently, the internal motor (not shown) of the APS film adapter 201 is driven to wind APS film so that a frame of the film which is to be scanned is exposed to the outside of the APS film adapter 201 through the scanning aperture 106 (step S311). Subsequently, it is determined whether the frame is currently exposed to the outside of the APS film adapter 201 through the scanning aperture 106 (step S313). If the frame is not yet exposed, control returns to step S311 to keep driving the internal motor of the APS film adapter 201. If the frame is currently exposed, rotation of the internal motor of the APS film adapter 201 is stopped (step S315). Subsequently it is determined whether the currently selected frame has been already scanned in the pre-scanning operation or main scanning operation at step S317 (step S317). If the currently selected frame has been already scanned, it is determined whether the main scanning operation is required to be performed with a CCD accumulation time (step S319). If the currently selected frame has not been already scanned, a CCD accumulation time determination process is performed (S321), and thereafter it is determined whether the main scanning operation is required to be performed with a CCD accumulation time (step S319). If it is determined at step S319 that the main scanning operation is required to be performed with the CCD accumulation time, the main scanning operation is performed (step S323), and subsequently control returns to the main process shown in FIG. 11. If it is determined at step S319 that the main scanning operation is not required to be performed with the CCD accumulation time, the system controller 140 stops passing the aforementioned small electrical current through the pre-scanning motor 113 (step S325), and thereafter the pre-scanning operation is performed (step S327). Upon completion of the pre-scanning operation, the system controller 140 resumes passing the small electrical current through the pre-scanning motor 113 (step S329), and subsequently control returns to the main process shown in FIG. 11.

In the main scanning operation at step S323, the main scanning motor 111 is driven to move the moving table 101 along the pair of parallel guide shafts 102. During such movement of the moving table 101, the currently selected frame is illuminated by the fluorescent lamp 121 so that the image on the frame currently exposed to the outside of the APS film adapter 201 through the scanning aperture 106 is formed on the CCD line sensor 123 via the image pick-up lens 122 to be scanned in the main scanning direction by the CCD line sensor 123 while being scanned in the sub-scanning direction due to the movement of the moving table 101. In the main scanning operation at step S323, the APS film adapter 201 needs to be held so as not to move with respect to the moving table 101 therein because the APS film adapter 201, which is much heavier than the 35 mm film holder 401, is easily moved by inertia when the moving table 101 moves in the main scanning operation. This is the reason why the system controller 140 passes a small electrical current through the pre-scanning motor 113 until the pre-scanning motor 113 is charged, but not to the extent wherein the pre-scanning motor 113 starts rotating during movement of the moving table 101 in the main scanning operation. Such a passage of a small electric electrical current through the pre-scanning motor 113 produces a torque which holds the pre-scanning motor 113 so that the pinion 114 thereof does not move by a small external force. This makes it possible to ensure a stable hold of the APS film holder 201 in the moving table 101.

On the other hand, in the case of the pre-scanning operation at step S327, the system controller 140 temporarily stops passing the small electrical current through the pre-scanning motor 113 at step S325 immediately before the commencement of the pre-scanning operation at step S327. In the pre-scanning operation at step S327, the pre-scanning motor 113 is driven to rotate the pinion 114 so that the APS film adapter 201, which has the rack 203 engaged with the pinion 114, moves in the chamber 105 of the moving table 101, to thereby perform the pre-scanning operation on the currently selected frame of APS film by the scanning device 120. Upon completion of the pre-scanning operation, the system controller 140 resumes passing the small electrical current through the pre-scanning motor 113 so that the moving table 101 does not move (step S329).

As can be understood from the above descriptions, the APS film adapter 201 is moved relative to the moving table 101 in the pre-scanning operation. Therefore, the contact array 205 of the APS film adapter 201 and the contact array 332 of the moving table 101 must be integrally moved, remaining in contact with each other, during movement of the APS film adapter 201 relative to the moving table 101 in the pre-scanning operation. To satisfy this requirement, the claw portion 207a of the resilient engaging leaf 207 of the APS film adapter 201 is engaged with the engaging recess 327 to make the APS film adapter 201 and the board holder 321 movable as an integral member when the pre-scanning motor 113 is driven to move the APS film adapter 201 after the APS film adapter 201 is inserted into the chamber 105. At the same time, the array of electrical contacts 205 come into contact with the array of electrical contacts 332, respectively, to establish electrical connection therebetween to supply power for the internal power of the APS film adapter 201 to the APS film adapter 201 via the contact board 331. At this time, the engaging claw portion 341a of the engagement/release lever 341 is engaged with the engaging pin 325 by the spring force of the extension coil spring 344 that biases the engagement/release lever 341 to rotate counterclockwise as viewed in FIG. 2, so that the board holder 321 that holds the contact board 331 is held to be integral with the moving table 101 and the guide plate 311.

Therefore, when the pre-scanning operation is performed in such a state where the engaging claw portion 341a is engaged with the engaging pin 325, the front end portion 206a of the engagement release cam 206 comes into contact with the release pin 343 of the engagement/release lever 341 by a forward movement (rightward movement as viewed in FIG. 2) of the APS film adapter 201. A further forward movement of the APS film adapter 201 causes the engagement release cam 206 to move the release pin 343 of the engagement/release lever 341 inwards (upwards as viewed in FIG. 2) to thereby rotate the engagement/release lever 341 clockwise as viewed in FIG. 2 against the spring force of the extension coil spring 344. This makes the engaging claw portion 341a disengaged from the engaging pin 325 of the board holder 321 to release the integral state between the guide plate 311 and board holder 321. Accordingly, when the APS film adapter 201 moves forward in the pre-scanning operation, the APS film adapter 201 and the board holder 321 integrally move forward while the former is pushing the latter. During this movement, the one-piece state between the guide plate 311 and board holder 321 is retained secondarily by the tension of the extension coil spring 344. This maintains the electrical connection between the contact array 205 and the contact array 332.

When the APS film adapter is moved reversely (leftwards as viewed in FIG. 2) after the pre-scanning operation is completed, the integral state between the APS film adapter 201 and the board holder 321 still remains held by the engagement of the claw portion 207a with the engaging recess 327 and the tension of the extension coil spring 344. Subsequently, a movement of the APS film adapter 201 to an initial position thereof with respect to the moving table 101 causes the front end portion 206a of the engagement release cam 206 to move to the release pin 343. This causes the release pin 343 to be disengaged from the engagement release cam 206, which in turn causes the engagement/release lever 341 to rotate counterclockwise as viewed in FIG. 2 by the spring force of the extension coil spring 344. Consequently, the engaging claw portion 341a is engaged with the engaging pin 325 of the board holder 321 to make the board holder 321 integral with the moving table 101. Thereafter, a further leftward movement of the APS film adapter 201 as viewed in FIG. 2 with respect to the moving table 101 causes the claw portion 207a to be disengaged from the engaging recess 327. As a consequence, the APS film adapter 201 can be removed from the moving table 101.

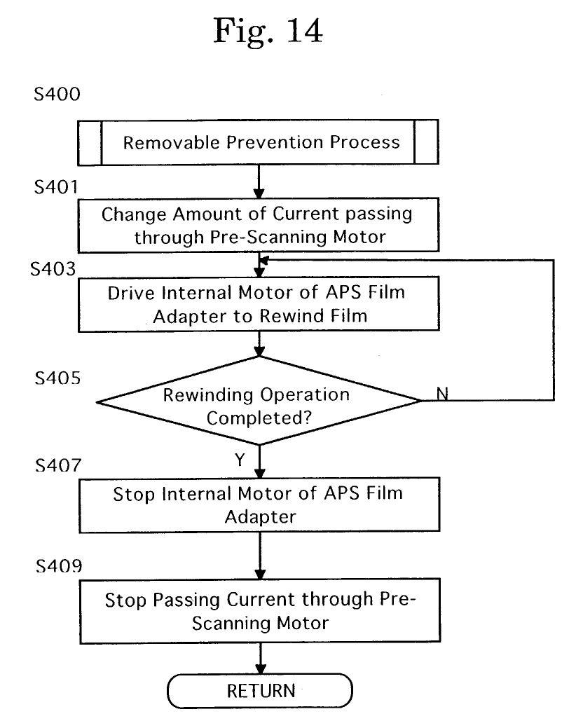

Upon completion of the main scanning operation or the pre-scanning operation in the above described manner, or when the main scanning or pre-scanning operation is not performed afterwards, control proceeds to the aforementioned stop process which starts at step S131. At step S131 it is determined whether the 35 mm film holder 401 is in the moving table 101. If the 35 mm film holder 401 is in the moving table 101, the pre-scanning motor 113 is driven to move the 35 mm film holder 401 to an initial position thereof (step S133), and subsequently it is determined whether the 35 mm film holder 401 is positioned at the initial position (step S135). If the 35 mm film holder 401 is not at the initial position, control returns to step S133 to keep driving the pre-scanning motor 113. If the 35 mm film holder 401 is at the initial position, rotation of the pre-scanning motor 133 is stopped (step S137), and control proceeds to step S139. If it is determined at step S131 that the 35 mm film holder 401 is not in the moving table 101, this means that the APS film adapter 201 is in the moving table 100, so that control proceeds to step S400 at which a removal prevention process (third subroutine) shown in FIG. 14 is performed. After the removal prevention process is completed, control proceeds to step S139. At step S139 the main scanning motor 11 is driven to move the moving table 101 to the initial position. Subsequently, it is determined whether the moving table 101 is positioned at the initial position (step S141). If the moving table 101 is not positioned at step S141, control returns to step S139 to keep driving the main scanning motor 11. If it is determined at step S141 that the moving table 101 is at the initial position, the main scanning motor 111 is stopped, and subsequently control ends.

The APS film adapter 201 can be removed from the moving table 101 manually by an operator of the film scanner 10 after the APS film adapter 201 is moved to a predetermined position with respect to the moving table 101. Due to this structure, if the APS film adapter 201 is manually removed from the moving table 101 with an emulsion-coated surface of APS film remaining exposed to the outside of the APS film adapter 201 through the rectangular aperture 204, there is a possibility of the exposed surface of film being damaged. To prevent this problem from occurring, the removal prevention process is performed at step S400. In the removal prevention process, the APS film adapter 201 cannot be removed from the moving table 101 unless APS film has been fully accommodated in the APS cartridge.

The removal prevention process at step S400 will be hereinafter discussed in detail with reference to the flow chart shown in FIG. 14. In the removal prevention process, firstly the system controller 140 changes the amount of electrical current passing through the pre-scanning motor 113 (step S401). This change of electrical current does not cause the pre-scanning motor 113 to generate substantial heat, even though the electrical current passing through the pre-scanning motor 113 at step S401 is greater than that at step S309. Subsequently, it is the internal motor of the APS film adapter 201 that is driven to rewind the film to fully accommodate the film in the APS cartridge (step S403). Subsequently, it is determined whether the rewinding operation is completed (step S405). If the rewinding operation is not completed at step S405, control returns to step S403. If the rewinding operation is completed, the internal motor of the APS cartridge is stopped (step S407). Subsequently, the system controller 140 stops passing electrical current through the pre-scanning motor 113 (step S409), and control returns to the main process.

As can be understood from the above description, the pre-scanning motor 113 does not generate substantial heat even though a relatively large electrical current continues to be passed through the pre-scanning motor 113 until the film is fully rewound and accommodated in the APS cartridge in the APS film adapter 201. Such a relatively large electrical current through the pre-scanning motor 113 produces a torque which holds the pre-scanning motor 113 so that the pinion 114 thereof does not rotate by a small external force. This holding torque is exerted on the engaging portion between the rack 203 and the pinion 114. Therefore, when someone tries to remove the APS film adapter 201 from the moving table 101, they need to remove the same with a force greater than the holding torque. In other words, unless someone tries to remove the APS film adapter 201 from the moving table 101 with a force greater than the holding torque, the APS film adapter 201 cannot be removed from the moving table 101. Accordingly, it is very difficult to remove the APS film adapter 201 from the moving table 101 with APS film remaining exposed to the outside of the APS film adapter 201 through the rectangular aperture 204. However, the APS film adapter 201 can be removed from the moving table 101 once the film is fully rewound and accommodated in the APS cartridge. This reliably prevents the APS film from being damaged.

Although the APS film adapter 201 cannot be removed easily from the moving table 101 with APS film still remaining outside the APS film adapter 201 in the above illustrated embodiment of the film scanner 10, the same function can be adopted for the case using the 35 mm film holder 401. Namely, it is possible for the film scanner 10 to be modified so that the 35 mm film holder 401 cannot be removed easily from the moving table 101 with the aforementioned holding torque when it is not preferable that the 35 mm film holder 401 be removed from the moving table 101 for a given reason.

Although the moving table 101 is provided with two stop projections, i.e., the stop projections 132 and 133 in the above illustrated embodiment of the film scanner 10, the moving table 101 can be provided with only the stop projection 133 since the APS film adapter 201 and the 35 mm film holder 401 can be prevented from being inserted into the chamber 105 from the opposite side thereof to a sufficient degree by the stop projection 133 alone. Accordingly, providing the moving table 101 with the stop projection 132 is optional. Alternatively, it is possible for the moving table 101 to be provided only with the stop projection 132. In either case, it is desirable for the film scanner 10 to be designed so as to make secure a film holding device (the APS film adapter 201 or the 35 mm film holder 401) and to facilitate manufacture of the moving table 101.

As can be understood from the above description, the APS film adapter and the 35 mm film holder, each of which serves as a film holding device, is reliably prevented from being inserted into the moving table from a wrong side thereof, the moving table and the film holding device are reliably prevented from being damaged, and unwanted images can be prevented from being read. Moreover, since the film holding device cannot be removed easily from the moving table due to a holding torque generated by motor with APS film remaining outside the APS cartridge, the APS film is reliably prevented from being damaged.

Although the film scanner 10 recognizes 35 mm filmstrip using a 35 mm film holder in the above illustrated embodiment, the film scanner can be modified to recognize any other size filmstrip with a film holder suitable for the filmstrip.

Obvious changes may be made in the specific embodiment of the present invention described herein, such modifications being within the spirit and scope of the invention claimed. It is indicated that all matter contained herein is illustrative and does not limit the scope of the present invention.

What is claimed is:

1. A film scanner comprising:
a film holding device for holding a film to be scanned;
an image pick-up device for scanning an image on said film in a main scanning direction; and
a moving table having said film holding device mounted thereon, said moving table being movable with respect to said image pick-up device in a sub-scanning direction,
wherein said moving table includes:
an insertion portion into which said film holding device is inserted to be mounted on said moving table, said insertion portion allowing said film holding device to be inserted into said insertion portion only from a predetermined side of said moving table; and
an insertion prevention device for preventing said film holding device from being inserted into said insertion portion in a position other than a predetermined position.

2. The film scanner according to claim 1, wherein said film holding device includes a portion having a vertically asymmetrical cross section taken along a plane orthogonal to a direction of insertion of said film holding device into said insertion portion.

3. The film scanner according to claim 2, wherein said film holding device includes a groove extending parallel to said insertion direction at a position away from a center-line of said film holding device parallel to said insertion direction, and wherein said insertion prevention device includes an insertion prevention projection on said insertion portion, which is inserted into said groove when said film holding device is inserted in a correct position.

4. The film scanner according to claim 2, wherein said film holding device includes a projection at a position away from a center line of said film holding device parallel to said insertion direction, and
wherein said insertion prevention device includes a stop projection formed in said insertion portion at a position to interfere with said projection of said film holding device when said film holding device is inserted into said insertion portion from a side thereof opposite to said predetermined side of said insertion portion with respect to said center line.

5. The film scanner according to claim 1, wherein said moving table includes a film-holding-device moving mechanism using a motor for moving said film holding device in said moving table,
wherein said film scanner further comprises a controller for controlling an electrical current passing through said motor of said film-holding-device moving mechanism, and
wherein said controller controls said electrical current to produce a torque for holding said motor which is greater than a torque necessary for said film holding device to be pulled out from said insertion portion.

6. The film scanner according to claim 1, wherein said film holding device serves as a film holder which holds a filmstrip cut out of a roll film and exposes the image of the film through a frame like aperture.

7. The film scanner according to claim 1, wherein said film holding device serves as a film adapter which accommodates a cartridge containing a roll film and winds out film from said cartridge so that one frame is exposed through an aperture formed on said film holding device.

8. The film scanner according to claim 7, wherein said film adapter comprises an APS film adapter which accommodates an APS cartridge containing an APS film and winds out the APS film from said APS cartridge to expose a requested image through the aperture, and
wherein said controller passes an electrical current through said motor to produce a torque for holding said motor in a state where at least a part of APS film is wound out from said APS cartridge within said APS film adapter.

9. The film scanner according to claim 1, further comprising:
a guiding mechanism for guiding said moving table in said sub-scanning direction; and
a motor for moving said moving table in said sub-scanning direction.

10. The film scanner according to claim 1, wherein said insertion portion comprises a T-shaped cross section in a plane orthogonal to a direction of movement of said moving table.

11. The film scanner according to claim 5, wherein said film holding device comprises a rack which is engaged with a pinion of said motor when said film holding device is inserted into said insertion portion of said moving table.

12. The film scanner according to claim 8, wherein said film holding device further comprises a first array of contacts which respectively come into contact with a second array of contacts formed on said film scanner when said film holding device is inserted into said insertion portion, said controller passing said electrical current through said motor via said first array of contacts and said second array of contacts.

13. A film scanner comprising:
a film holding device for holding film to be scanned;
an image pick-up device for scanning said film in a main scanning direction;
a moving table guided in a sub-scanning direction orthogonal to said main scanning direction, said film holding device being inserted into said moving table with said film being held by said film holding device; and
a driving system for driving said moving table in said sub-scanning direction with respect to said image pick-up device;
wherein said moving table comprises:
a chamber into which said film holding device is inserted to be mounted on said moving table, said chamber allowing said film holding device to be inserted into said chamber only from a predetermined side thereof; and
an insertion prevention device for preventing said film holding device from being inserted into said chamber from a side other than said predetermined side.
